(19) United States
(12) Patent Application Publication
(10) Pub. No.: US 2011/0180373 A1
(43) Pub. Date: Jul. 28, 2011

(54) BUFFER CONVEYOR FOR CONVEYING AND BUFFERING PRODUCTS

(76) Inventors: Johannes Wilhelmus Broers, Oosterblokker (NL); Wouter Balk, Baambrugge (NL)

(21) Appl. No.: 13/057,551

(22) PCT Filed: Aug. 4, 2009
(86) PCT No.: PCT/NL09/50479

§ 371 Date: Mar. 29, 2011

(30) Foreign Application Priority Data
Aug. 6, 2008 (NL) 2001875

(51) Int. Cl. B65G 47/53; B65G 15/00

(52) U.S. Cl. 198/607

(57) ABSTRACT

A buffer conveyor for conveying and buffering products comprises a first and a second conveyor, which move at least substantially parallel to each other in helical paths about a common vertical axis, albeit in opposite directions.

A transfer unit is movable parallel to the first and the second conveyor in the aforesaid path with its inlet (HA) and outlet (HB) ends. The transfer unit is provided with at least one separate, drivable transfer element for transferring the products from the first conveyor to the second conveyor, so that the products can be transferred from the inlet end of the first conveyor to the discharge end of the second conveyor via the transfer unit. The transfer unit comprises a drive unit for moving the transfer unit along the paths of the respective conveyors with its ends in dependence on the speeds of the first and the second conveyor.

The transfer element of the transfer unit describes an at least substantially horizontal path between the inlet end and the outlet end and extends outside the area defined by the adjacent paths of the first and the second conveyor.

### CROSS-REFERENCE TO RELATED APPLICATION

This application is a Section 371 National Stage Application of International Application PCT/NL2009/050479 filed Aug. 4, 2009 and published as WO/2010/016761 in English.

### BACKGROUND

The discussion below is merely provided for general background information and is not intended to be used as an aid in determining the scope of the claimed subject matter.

An aspect of the present invention relates to a buffer conveyor for conveying and buffering products.

Buffer conveyors according to the prior art are known in a great many versions thereof. U.S. Pat. No. 5,413,213 shows two types of buffer conveyors. The first type is shown in FIGS. 1-4 and FIGS. 7, 8. The buffer conveyor in question comprises a single conveyor belt, which winds in double helical paths from the lower end and from the upper end, with the paths from the lower end forming the first and the second conveyor. The paths from the upper end form an inoperative part of the buffer conveyor. The first conveyor blends into the second conveyor at the upper end in that the conveyor belt is lifted off its guide and moves back onto the guide of the first conveyor via the transfer unit at the second conveyor. The location where the conveyor belt is lifted off its guide can be varied along the length of the first (and thus also the second) conveyor, as a result of which the buffering length is varied, which is compensated in the inoperative part of the conveyor belt (a compensation loop). A drawback of said construction is that the construction in which the conveyor belt, which is under a tensile force, is to be moved onto and off the guide construction, is complex partially on account of the compensation loop that is required, whilst it is furthermore not very advantageous for technical (driving) reasons to drive one entire, long conveyor belt.

These drawbacks are eliminated in the second type of buffer conveyor shown in FIGS. 5 and 6 of U.S. Pat. No. 5,413,213. In said type of buffer conveyor, two helically wound conveyor belts are nested together, so that the windings of the first and the second conveyor extend parallel to each other, one above another. The transfer unit is mounted on a column and comprises two transfer elements in the form of chain conveyors, one for removing products from the first conveyor and one for transferring products to the second conveyor. The transfer from one chain conveyor to the other chain conveyor takes place via a chute, and it will be understood that such a transfer unit can only be used with certain types of products, in this case cigarettes.

U.S. Pat. No. 6,152,291 shows yet another type of conveyor. Here, two conveyor belts are used for forming the first and the second conveyor, which extend parallel to each other in the helical path. The transfer unit is guided in the space between the first conveyor and the second conveyor for transferring the products from the first conveyor to the second conveyor and for moving along the first and the second conveyor for adjusting the buffering length. Said buffer conveyor has the drawback that the products are subject to an abrupt change of direction in the transfer unit. Not all products are unaffected by this. Furthermore, longer products cannot be transferred with the transfer unit.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

The buffer conveyor according to an aspect of the invention combines all the advantages of the various types of buffer conveyors, without exhibiting the drawbacks thereof. In this embodiment the path of the transfer unit extends at least substantially horizontally (i.e. at most at a small angle to the horizontal) between the inlet end and the outlet end, and as such the buffer conveyor is suitable for buffering all kinds of products, not only cigarettes or the like. Since the path extends outside the area defined by the adjacent paths of the first and the second conveyor, the path can be configured to make wide bends between the inlet end and the outlet end, so that abrupt changes of direction, and thus also unstable or fragile products, can be prevented, whilst it is also possible to buffer long products. The first and the second conveyor and the transfer element include separate conveying elements, which can be optimally adapted to the circumstances. If the first and the second conveyor extend concentrically one above the other and have the same radius of curvature—and are thus nested, as it were—the transfer unit can extend at least substantially horizontally from the first conveyor to the second conveyor without having to cross the other conveyor.

The general inventive concept can be worked out in various ways.

The transfer unit can join the first and the second conveyor with its inlet and outlet ends at connecting positions which are staggered in the circumferential direction of the buffer conveyor, for example by more than 90°, preferably about 180°, seen in top plan view. In the latter case, the inlet and outlet end are positioned diametrically opposite each other, and the products will in fact leave the transfer unit in the same direction as the direction in which they entered the transfer unit. In the nested version, the two buffer conveyors can extend one above the other, an equal distance apart, so as to realise a horizontal path of movement of the transfer unit. Said at least one transfer element of the transfer unit can move in a substantially S-shaped path. The radius of curvature of the bends thereof may be about half the average radius of the first and the second conveyor.

The inlet and outlet ends of the transfer unit can join the first and the second conveyor, respectively, in lateral direction and be provided with a deflector at the connecting location for transferring the products from the conveyor to the transfer element and vice versa. Such a manner of transferring can be utilised for products suitable for being deflected, such as bottles, for example.

The transfer unit and the transfer element may be configured in many ways.

In a first embodiment, said at least one transfer element comprises an endless conveyor belt having a conveying portion and a return portion which either join each other via pulleys and extend one above the other, or join each other in horizontal direction and move along different paths, for example jointly describing an 8-shaped path in the case of an S-shaped path from the inlet end to the outlet end. The first possibility provides the simplest construction, whilst in the case of the second version the overall height of the transfer unit can remain small, in particular at the inlet end and the outlet end.

According to another possibility, said at least one transfer element comprises two rotary discs, which join one another on the one hand and which join the first and the second conveyor, respectively, on the other hand. This is a comparatively inexpensive solution.

For products which are comparatively unstable but which are suitable for being clamped, a transfer unit can be used in which said at least one transfer element comprises two endless conveying elements, which extend substantially parallel to each other, with a predetermined spacing between them, in the path between the inlet end and the outlet end, and which transport the products, preferably clampingly, between them.

The buffer conveyor may also be designed so that products can be transported in suspended condition, which can be realised by arranging both the transfer element and the first and second conveyor for suspended transportation.

### BRIEF DESCRIPTION OF THE DRAWINGS

Further aspects and advantages of the buffer conveyor according to the invention will become apparent from the following description, in which reference is made to the drawings, which are very schematic representations of embodiments of the invention.

FIG. 1 is a vertical sectional view of a first embodiment of the buffer conveyor.

FIG. 2 is a larger-scale view of the detail II in FIG. 1.

FIG. 3 is a very schematic top plan view of the transfer element of the transfer unit and the adjoining parts of the first and the second conveyor of the buffer conveyor of FIG. 1.

FIGS. 4-9 are views corresponding to FIG. 3 of further embodiments of the buffer conveyor.

FIGS. 10, 11 and 12 are views comparable to the view of FIG. 2, showing three ways of supporting the transfer unit and/or driving the transfer element.

### DETAILED DESCRIPTION

The drawings show a buffer conveyor for conveying and buffering products. Such buffering in general takes place in a production line in which the products are subjected to different processing or treatment steps at different locations and in which temporary differences in the processing rates must be compensated at said locations. The products may include containers, for example, in particular containers such as bottles, cans, pots, cartons and the like, but also a variety of other parcel goods, such as books, magazines, cigarettes, boxes, cases or the like are conceivable. In the case of bottles or cartons, the processing line can include a filling line for filling the containers in question, such as a bottling line for filling the bottles with a beverage. The buffer conveyor may for example be disposed between a depalletising station and a washing and/or filling station, between the filling station and a labelling station or between the labelling station and a packaging station. Other applications are also conceivable, of course.

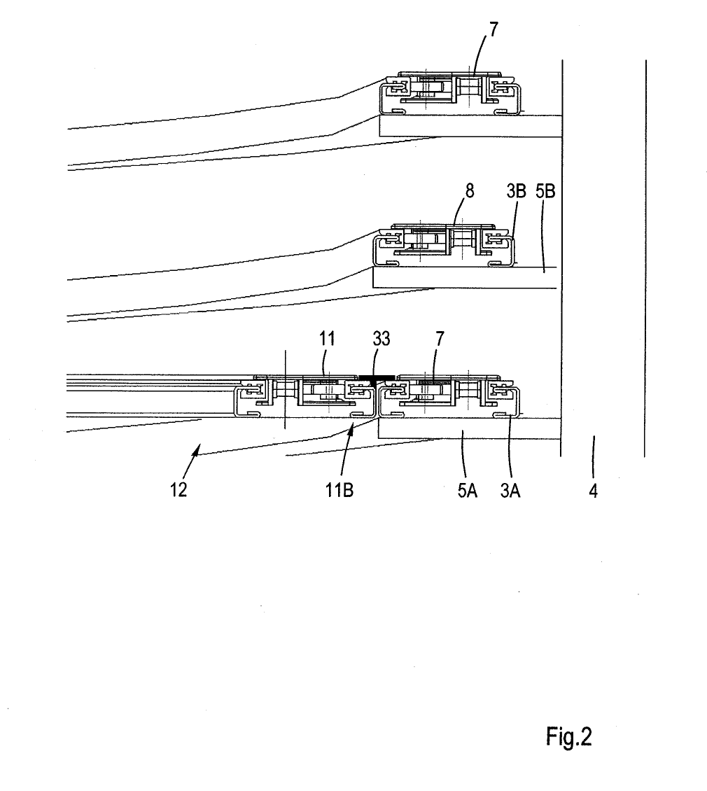

The illustrated buffer conveyor comprises a frame 1, in this case comprising a number of external columns 4, which are disposed on a base 2 of the frame. Helical guide chutes 3A, 3B (FIG. 2, are attached to the columns of the frame via spiral supports 5A, 5B. Also all kinds of other frame constructions are conceivable, of course. End rollers are provided at the inlet and the outlet of the conveyor, and return chutes of the frame (not shown) extend from the upper end of the helical guide chutes 3A, 3B. In this embodiment of the buffer conveyor, the guide chutes 3A, 3B and the return chutes support a first elongated conveyor 7 and a second elongated conveyor 8, respectively, which may each comprise one or more conveyor belts or the like, for example, which extend beside each other. The conveying portion and the return portion of the two conveyors 7, 8 move along different paths. It is also conceivable to use an embodiment in which the return portion is led along the underside of the guide chute 3A, 3B for the conveying portion. Examples of the path of movement of the conveyors and alternative frame solutions are to be found in WO2005/102877, WO2007/123401, WO2008/079010 and EP 1840725, whose contents are incorporated herein by reference thereto.

Several embodiments of the first and the second conveyor 7, 8 are possible, whilst it is preferable in the case of belt conveyors that a more or less closed conveying surface is obtained. Examples of such belt conveyors are slat conveyors, link conveyors, stainless steel slat chain conveyors, textile belt conveyors, PVC belt conveyors, steel belt conveyors and the like, which latter types are generally only suitable for use in a straight, i.e. non-curvilinear conveyor. The invention also extends to rectilinear conveyors, however, to conveyors which are only curved in a horizontal plane, to conveyors which (also) extend in vertical direction, to suspended conveyors and to conveyors not configured as endless conveyors but, for example, as a roller conveyor or as an air conveyor or a magnetic conveyor. The illustrated construction of the conveyors 7, 8 is comparable to the construction according to WO 99/11547.

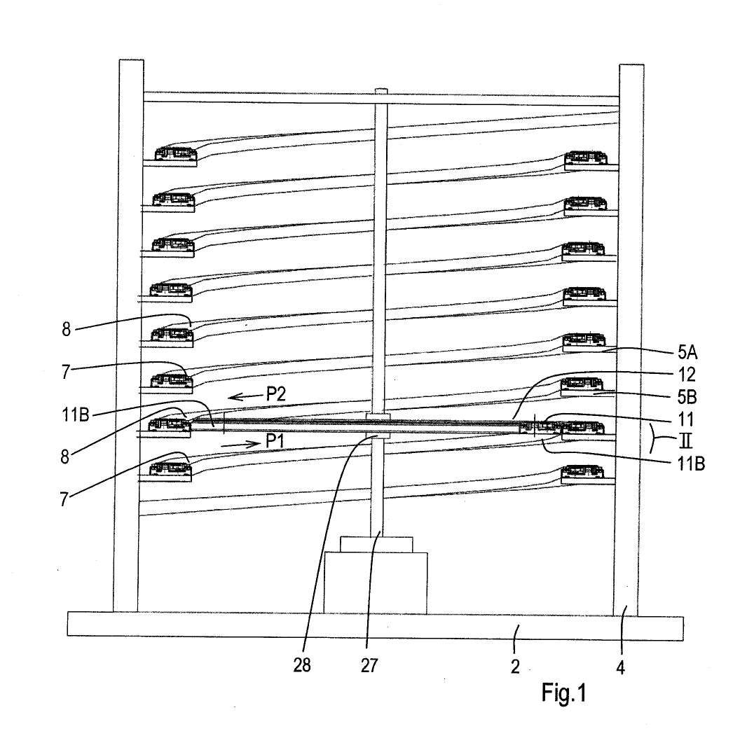

In the embodiment that is shown in FIGS. 1 and 2, the helical chutes 3A, 3B each comprise 4 windings, but it is also possible to use a larger or a smaller number of windings, depending on the application in question. For example, the use of guide rollers on the conveyor belts of the conveyors 7, 8 makes it possible to drive the conveyor belts over a large number of windings without any driving problem. The two conveyors 7, 8 each have their own driving motor, which motors are mounted near the upper end 5 in this case, and which drive the associated conveyor 7, 8. The two conveyors may also be connected to supplying or discharging conveyors, in which case they are driven and controlled by said conveyors, therefore. The guide construction for the conveyor belts that is shown in FIGS. 1 and 1A is comparable to the guide construction shown in WO 99/11547 and WO 2008/039686, whose contents are incorporated herein by reference thereto.

The two conveyors 7, 8 can be driven independently of each other, in this case in opposite directions, i.e. products are conveyed upwards over the conveying surface of the first conveyor belt 7 from an inlet end at the lower end 4, as indicated by the arrow P₁, and downwards again over the conveying surface of the second conveyor 8 (see the arrow P₂) towards a discharge end at the lower end 4. At the location indicated by the arrows P_{1A} the products are transferred from the conveying surface of the first conveyor 7 to an inlet end 11A of a transfer element, in this case a transfer belt 11 of a transfer unit 12, whilst the products are transferred from the outlet end 11B of the transfer belt 11 to the conveying surface of the second conveyor belt 8 at the location indicated by the arrows P_{1B}. It would also be possible, of course, for the transport to take place from the top to the bottom and subsequently up again, if the application should require so.

The transfer unit 1 is movable within the buffer conveyor, in this case being guided and supported in the space radially inwards of the conveyors 7, 8. The transfer unit extends outside the area defined by the adjacent paths of the first and the second conveyor 7, 8. Seen in top plan view, said area is defined by the inner radius of the first, inner conveyor 7 and the outer radius of the second, outer conveyor 8, which radii of the two conveyors are the same in this case.

The position of the transfer unit 12 depends on the required buffering capacity between the inlet end and the discharge end of the buffer conveyor. If the supply rate of the first conveyor 7 is higher than the discharge rate of the second conveyor 8, the excess of products being supplied must be buffered in the buffer conveyor, and the transfer unit 12 must move away from the inlet end of the buffer conveyor in that case so as to collect more products on the buffer conveyor. If in another case the speed of the supplying first conveyor 7 is lower than the speed of the discharging second conveyor 8, the transfer unit 12 must move in the direction of the discharge end so as to supply buffered products to the discharge end. In practice the buffer conveyor is for example capable of buffering a number of products which suffices for 5-15 minutes of buffering time, for example, which period of time generally suffices for restoring the balance between the supply rate and the discharge rate. In fact the transfer unit acts to shift the transition between an active part and an inoperative part of the conveyors 7, 8, so that the length of the active part of the conveyors can be adapted to the circumstances.

In the example shown in FIG. 1, the transfer unit 12 rotates about a shaft 27 while the buffering length is being changed, which shaft coincides with the central axis of the helical paths of the conveyors 7, 8. The transfer unit will also have to move along the shaft with the aid of a sleeve 28 or the like in order to follow the change in height of the helix.

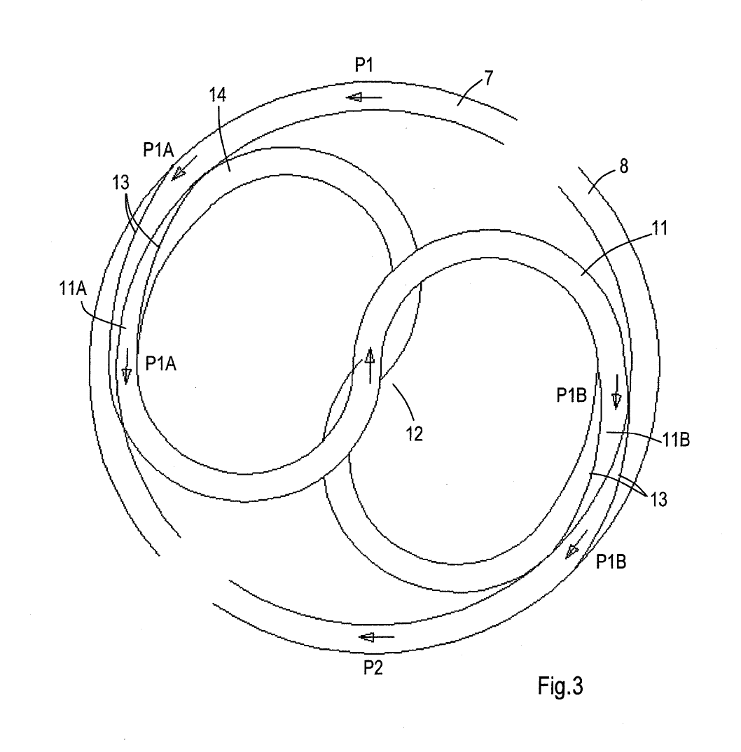

In the embodiment shown in FIG. 3, the transfer belt 11 of the transfer unit 12 has a conveying path which extends substantially in the shape of an S between the inlet end 11A and the discharge end 11B. In this case the transfer between the transfer belt 11 and the conveyors 7, 8 is effected by deflecting guides 13 which are either active or passive. In the former case, the deflecting guides will be driven and actively transfer the products supplementary to the conveying force being exerted by the conveyors 7, 8 and the driven transfer belt 11. In this case the transfer element joins the conveyors 7, 8 with its inlet and outlet end 11A, 11B, respectively, at the inner radius in each case.

The first and the second conveyor 7, 8 extend one above the other with an at least substantially constant spacing between them and have the same diameter in the helical path. The helical paths of the conveyors 8, 8 are thus nested, as it were. The area defined by the conveyors is located between the inner and outer radii of the two conveyors 7, 8, seen in top plan view. The path of the transfer element 11 of the transfer unit 12 can extend horizontally at all times, because the inlet end 11A adjoining the first conveyor 7 is located at the same height as the outlet end 11B at the second conveyor 8 half a winding upstream. The transfer unit need not cross a conveyor, whilst the buffering length will be maximal with a given outer diameter of the buffer conveyor. The nested conveyors 7, 8 have a larger pitch than in the situation in which the conveyors would be arranged beside each other. To keep the pitch within bounds, the conveyors 7, 8 are preferably disposed one above the other. This makes the buffer conveyor in particular suitable for relatively stable and low-height products.

The transfer belt 11 of the transfer unit 12 has construction similar to that of the conveyors 7, 8 and is provided with a bridge member 33 at the outer side of the inlet and outlet end 11A, 11B in order to effect a smooth lateral transfer of products between the conveyors 7, 8 and the transfer belt 11 in cooperation with the deflecting guides (not shown). As FIGS. 1 and 2 show, the transfer belt 11 extends horizontally from the conveyor 7 to a diametrically opposite winding portion of the conveyor 8. The S-shaped path of FIG. 3 will have to extend slightly differently if use is made of a vertical shaft 27 as shown in FIG. 1, because the path of the transfer element extends through the shaft in FIG. 3. It is also possible to use a different construction for the shaft 27, of course.

In this embodiment, a return portion 14 of the endless transfer belt 11 moves along a different path than the conveying portion and in fact continuously connects to the inlet and outlet ends 11A, 11B of the transfer belt 11. This has the advantage of realising a small overall height of the transfer belt 11 at the inlet and the outlet end. Both the first and second conveyors 7, 8 and the transfer belt 11 may be provided with lateral guides at their outer radius to prevent products falling off sideways. Especially when higher speeds are used, the centrifugal force can force products outwards, so that a lateral guide is necessary in order to keep the products on the conveyor.

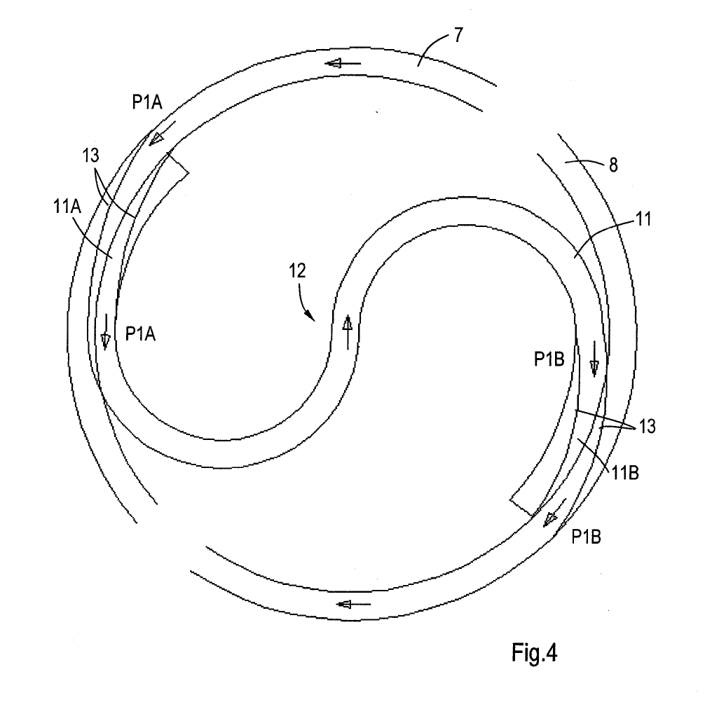

The embodiment according to FIG. 4 shows a transfer unit 12 whose transfer element is made up of a transfer belt 11 again. Said transfer belt 11 has a conveying portion and a return portion which move along the same path, however, with the return portion extending under the S-shaped part of the products, therefore. In this case the transfer unit 12 is combined with a nested version of the conveyors 7, 8 again, with the transfer belt 11 joining the first conveyor 7 and the second conveyor 8 in lateral direction and use being made of deflecting guides 13. This buffer conveyor is of relatively simple construction.

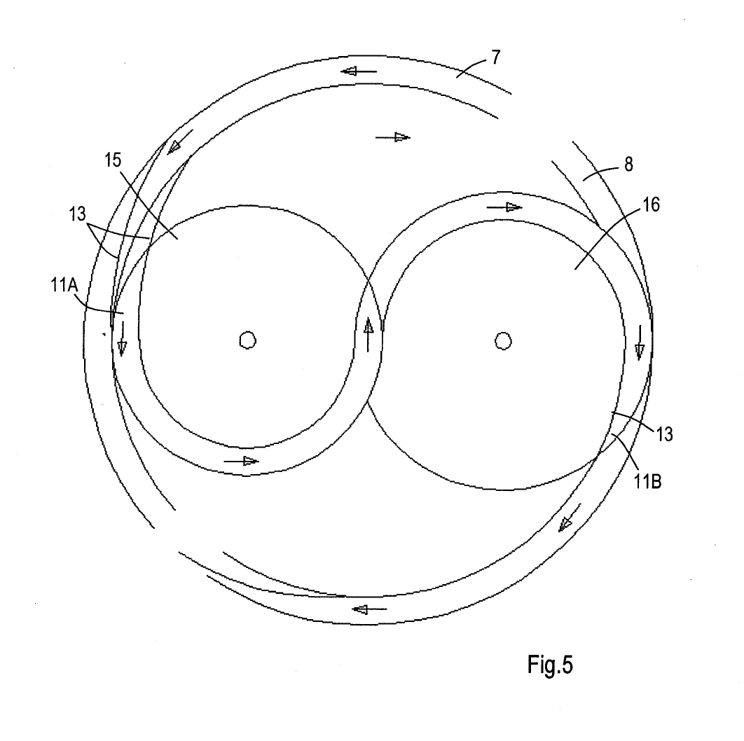

FIG. 5 shows a variant of the buffer conveyor of FIG. 4, in which the transfer unit has been substituted for another type of transfer unit, the transfer element being provided with two transfer discs 15, 16, which adjoin each other on the one hand and the first and the second conveyor 7, 8, respectively, on the other hand. Deflecting guides 13 are used at the transition between the first conveyor 7 and the first transfer discs 15 for pushing the products sideways off the first conveyor 7 onto the first transfer disc 15. At the connection between the transfer discs 15 and 16, the transfer disc 15 overlaps the disc 16, so that the products can be transferred from the first transfer disc 15 to the transfer disc 16 without undergoing a change of direction. The same is the case at the transition from the transfer disc 16 to the second conveyor 8, where the transfer disc 16 overlaps the second conveyor 8 and the products can be transferred from the transfer disc 16 to the second conveyor 8 without undergoing a change of direction. In this embodiment, thin discs are preferably used, so that the transitions will not cause any significant difference in height.

Alternatively, a sideways connection to a deflecting guide 13 can in any case be realised at the connection from the second transfer disc 16 to the second conveyor 8. This embodiment of the transfer unit comprising transfer discs is relatively easy to realise, and consequently inexpensive to manufacture. The diameters of the two discs 15, 16 are preferably substantially identical, but they may be adapted in dependence on the situation. The rotational speeds will preferably be geared to the diameters, so as to achieve a transfer speed that is the same everywhere.

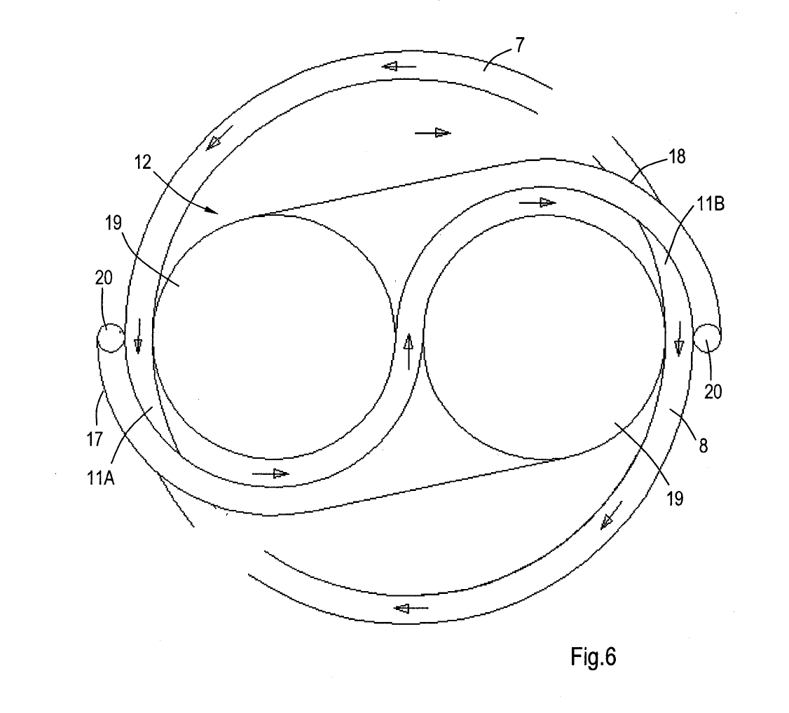

The embodiment of FIG. 6 shows a further variant of the transfer unit 12, in which the transfer element is provided with two clamping straps 17, 18, which define an S-shaped path from the inlet end 11A to the outlet end 11B in that the clamping straps 17, 18 extend with a predetermined spacing between them in said path and are driven in the same direction and at the same speed. The clamping straps 17, 18 are to that end passed over pulleys 19, 20, which rotate about substantially vertical axes. The clamping straps 17, 18 cross the first conveyor 7 and the second conveyor 8 at the inlet end 11A and the outlet end 11B, respectively, so as to function as a deflecting guide at the inlet end 11A and make it possible for the products to be transferred to the second conveyor belt 8 without any changes in direction at the outlet end 11B. In the path of the transfer element 11, the clamping straps 17, 18 are spaced apart by a distance such that the products to be transferred are guided, or clamped, in the desired manner, whilst the products may or may not be supported at a bottom side by the transfer unit 12. This embodiment is quite suitable for use with products which are unstable but capable of being clamped.

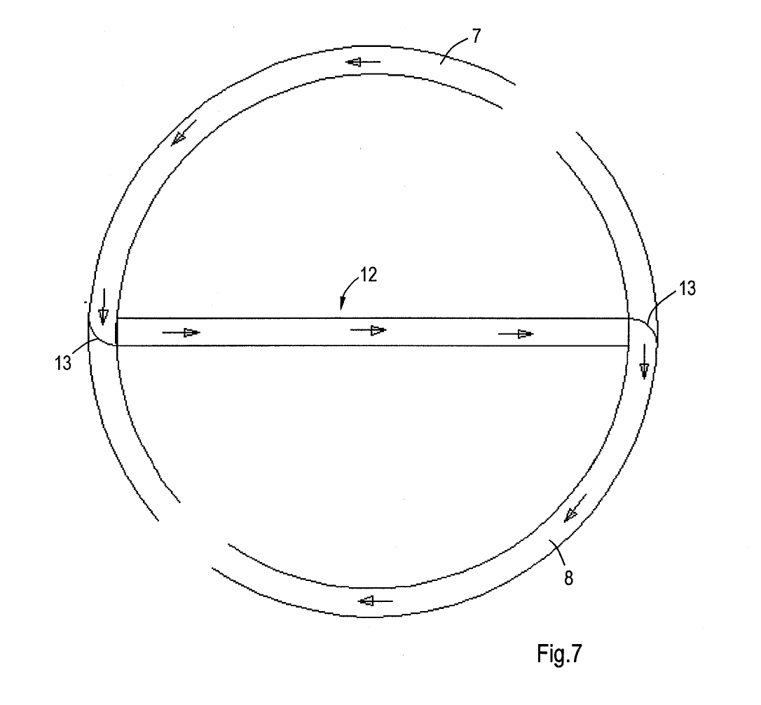

FIG. 7 shows another embodiment of a buffer conveyor, in which the transfer element of the transfer unit 12 is rectilinear and extends directly between the diametrically opposite inlet and outlet ends 11A, 11B, therefore. The deflecting guides 13 serve to deflect the products with a small radius of curvature through a right angle, so that this embodiment is especially suitable for products which are transported at a comparatively low speed, which are relatively stable and which are capable of withstanding some pushing pressure. This is in particular the case with products having a round horizontal section, such as bottles or cans. The transfer unit 12 will preferably be provided with lateral guides, in particular at the inlet end 11A thereof. If the path from the inlet end 11A to the outlet end 11B slopes downwards, the transport on the transfer element of the transfer unit 12 can take place under the influence of the force of gravity, but the transfer element may also be configured as a transfer belt 11. If desired, the transfer unit 12 may be (slightly) curved rather than entirely rectilinear, but nevertheless join the first and second conveyor 7, 8 at right angles. A different joining angle is also conceivable. In fact, the products also move in a substantially S-shaped path in this embodiment, because the products first move in anti-clockwise direction on the first conveyor 7 and then, after being transferred on the transfer unit 12, in clockwise direction on the second conveyor 8.

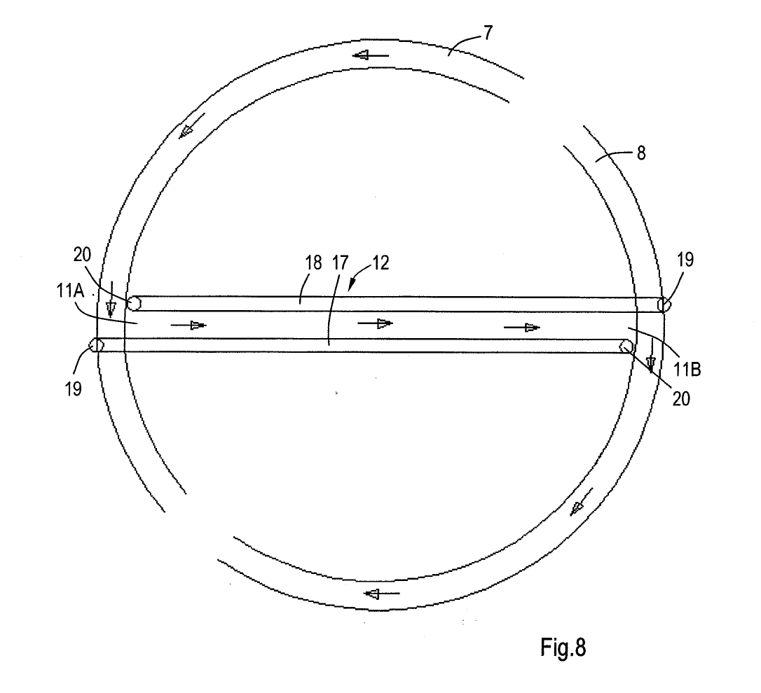

In the variant that is shown in FIG. 8, the transfer unit 12 is again provided with clamping straps 17, 18 functioning as transfer elements, so that this embodiment is a combination of the embodiments shown in FIGS. 6 and 7.

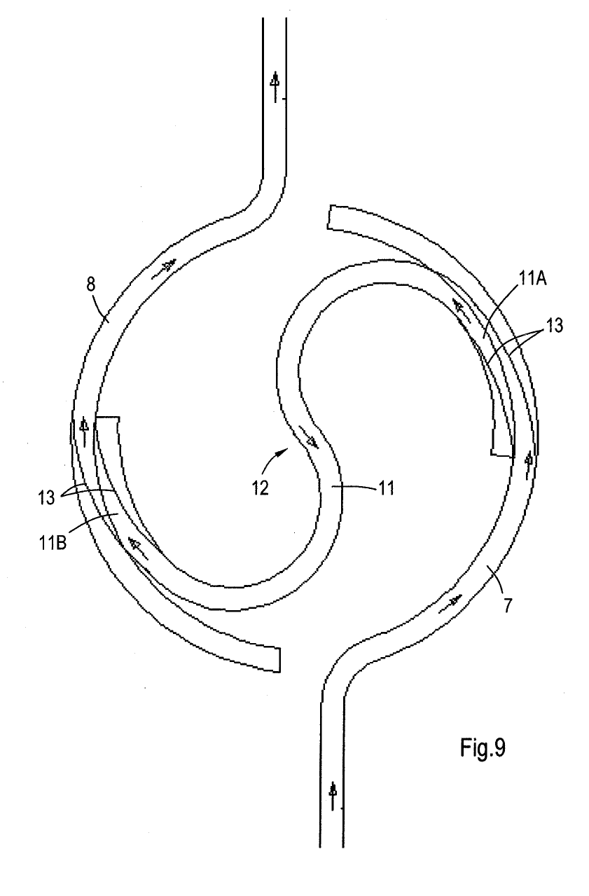

The embodiment shown in FIG. 9 is different from the preceding embodiments in that the conveyors 7, 8 do not describe a helical path but only a horizontal arced path. The transfer unit 12 and the transfer element (transfer belt 11) are comparable to those shown in FIG. 4, with the inlet end 11A and the outlet end 11B of the transfer belt 11 of the transfer unit 12 joining the first and the second conveyor 7 and 8, respectively, from the inner radius of the arced paths, and the path of said at least one transfer element of the transfer unit extending horizontally between the inlet end and the outlet end. The conveyors 7, 8 do not extend parallel to each other in this embodiment, but they extend in line with each other in an arced path, having the same center of curvature and, in this case, also the same radius of curvature. The transfer unit 12 has the same function in this embodiment, in which connection it is noted, however, that only a very limited buffering capacity can be realised, of course, so that this embodiment can only be used when a very small buffering capacity is required. The only difference with the preceding embodiments is that the conveyors do not extend in a helical but in a horizontal path.

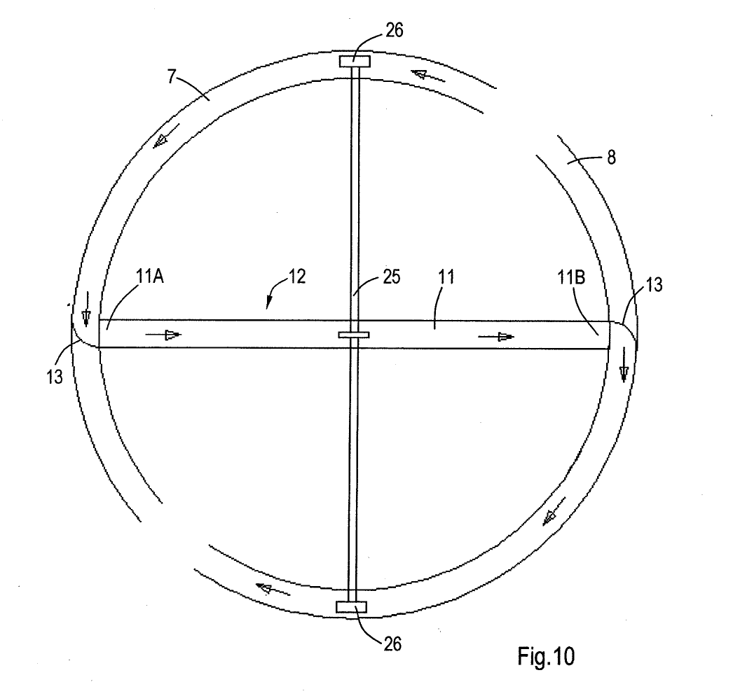

FIGS. 10-12 very schematically show possibilities for driving the transfer unit 12 and the transfer element.

In the embodiment of FIG. 10, the transfer unit 12 is provided with a drive shaft 25, which rigidly connects two wheels 26 at the ends thereof. Said wheels are in engagement with the first and the second conveyor 7, 8, respectively, which move in the same direction at diametrically opposite locations. If the two conveyors 7, 8 move at the same speed, the wheels will rotate at the same speed in the same direction, therefore, so that the drive shaft 25 will not experience any force about the axis of rotation of the transfer unit 12 and the transfer unit 12 will remain stationary. Once the conveyors 7, 8 start to move at different speeds, the drive shaft 25 will start to rotate in anti-clockwise or clockwise direction, carrying along the transfer unit 12, so that the buffering length is changed. The wheels 26 may be drivingly connected to the conveyor 7, 8 through friction or via teeth or the like. The wheels 26 may also be rigidly connected in a different manner, for example via two coupled shafts, which may or may not extend at an angle relative to each other, so that the same effect is achieved. The shaft 26, which rotates about its own axis, can also be utilised for driving the transfer element, which may for example be configured as a transfer belt, for example via a sprocket wheel which is mounted under the transfer belt 11 for driving the same and which is connected to the drive shaft 25 via a chain.

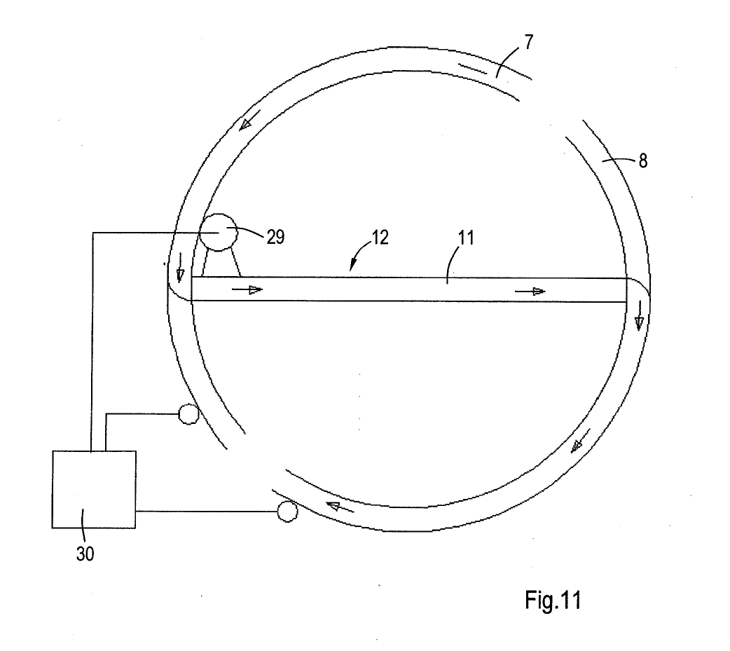

FIG. 11 very schematically shows the driving arrangement for the buffer conveyor of FIG. 7, in which the drive unit 29 for the transfer unit 12 engages one of the conveyors 7, 8 or the guide chute. In the former case, the motion will be mechanically taken off the conveyors, and in the latter case this will take place electronically, as shown. The speed of the conveyors 7, 8 can then be measured and the driving motor of the transfer unit 12 can be controlled from a control unit 30 on the basis of said measurement. When a mechanical transmission is used, the unit 30 will be a gearbox with a differential transmission. The drive unit 29 can also serve to drive the transfer element of the transfer unit 12.

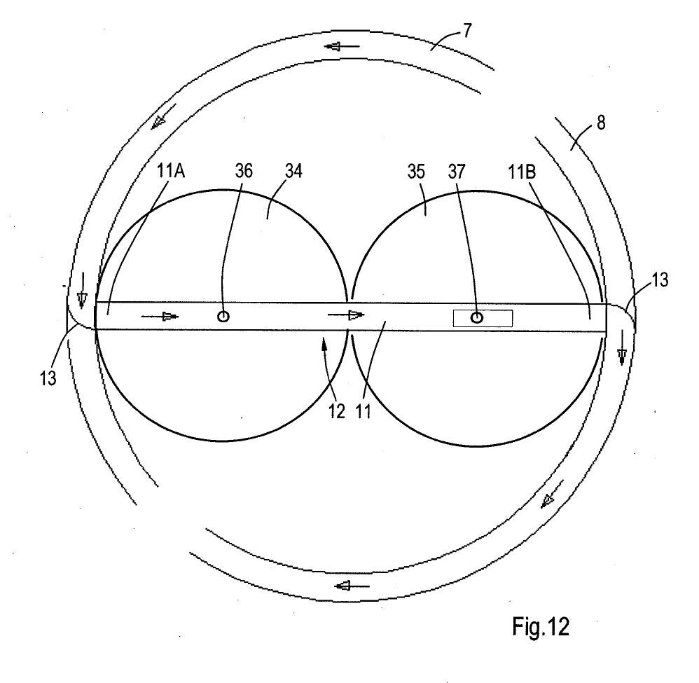

FIG. 12 shows yet another driving possibility, in which the transfer unit 12 is provided with two equally sized driving discs 34, 35, which are each rotatable about their own vertical shaft 36, 37, respectively, which is supported by the transfer unit 12. The driving discs 34, 35 are in engagement with the conveyors 7, 8, respectively, on the one hand and with one another, at their facing sides, on the other hand. As a result, the rotation of the transfer unit 12 is the result of the difference in the speed of the conveyors 7 and 8. The drive of the transfer belt 11, the rotating lateral guide, all of the clamping straps or strings 17, 18 can be derived from the rotary motion of the driving discs 34, 35.

From the foregoing it will be apparent that the invention provides a buffer conveyor which stands out for the possibilities its provides for transferring all kinds of products, such that the buffer conveyor can be optimally adapted to said products through the selection and arrangement of the various parts of the buffer conveyor.

The invention is not limited to the embodiment as shown in the drawings and described in the foregoing, which can be varied in many ways within the scope of the invention as defined in the claims. Thus it is possible to combine the various embodiments, for example types of transfer unit with different arrangements of the conveyors. Thus, most transfer units of the conveyors 7, 8 describing a helical path can also be used with the flat version of the conveyors 7, 8 shown in FIG. 9. Instead of extending horizontally, the transfer element of the transfer unit can also extend at a small angle from the inlet end to the outlet end, for example at an angle of about 5° at most. This may for example be the case if the inlet end and the outlet end are not positioned diametrically opposite each other, if the first and the second conveyor are not nested with an equal spacing between them or are positioned differently relative to each other. Furthermore it is possible to have the transfer element driven by a driving motor which operates independently of the speeds of the first and the second conveyor.

1. A buffer conveyor for conveying and buffering products, comprising:
at least a first elongated conveyor, which can be driven in a first direction and which has an inlet end,
a second elongated conveyor, which can be driven in a second, opposite direction and which has a discharge end, which first and second conveyor at least partially extend in helical paths about a common vertical axis, at least substantially parallel to each other, albeit in opposite directions,
a transfer unit having an inlet end and an discharge end, which are movable at least substantially parallel to the first and the second conveyor in the aforesaid path, which transfer unit is provided with at least one separate, drivable transfer element for transferring the products from the first conveyor to the second conveyor, so that the products can be transferred from the inlet end of the first conveyor to the discharge end of the second conveyor via the transfer unit, which transfer unit comprises a drive unit for moving the transfer unit along the paths of the respective conveyors with its ends,
wherein said at least one transfer element of the transfer unit describes an at least substantially horizontal path between the inlet end and the outlet end and extends outside the area defined by the adjacent paths of the first and the second conveyor.

2. The buffer conveyor according to claim 1, wherein the transfer unit joins the first and the second conveyor with its inlet and outlet ends at connecting positions which are staggered in the circumferential direction of the buffer conveyor.

3. The buffer conveyor according to claim 2, wherein said connecting positions are staggered relative to each other by more than 90°, preferably about 180°, seen in top plan view.

4. The buffer conveyor according to claim 1, wherein said at least one transfer element of the transfer unit moves in an S-shaped path from the inlet end to the outlet end.

5. The buffer conveyor according to claim 1, wherein the inlet and outlet ends of the transfer unit join the first and the second conveyor, respectively, in lateral direction and are provided with a deflector at the connecting location configured to transfer the products from the conveyor to the transfer element and vice versa.

6. The buffer conveyor according to claim 1, wherein said at least one transfer element comprises an endless conveyor belt having a conveying portion and a return portion which either join each other via pulleys and extend one above the other, or join each other in horizontal direction and move along different paths.

7. The buffer conveyor according to claim 1, wherein said at least one transfer element comprises two rotary discs, which join one another on the one hand and which join the first and the second conveyor, respectively, on the other hand.

8. The buffer conveyor according to claim 1, wherein said at least one transfer element comprises two endless conveying elements, which extend substantially parallel to each other, with a predetermined spacing between them, in the path between the inlet end and the discharge end, and which transport the products between them.

9. The buffer conveyor according to claim 1, wherein both said at least one transfer element and said first and second conveyor are arranged for suspended transportation of the products.

10. The buffer conveyor according to claim 1, wherein the path of the transfer element extends substantially rectilinearly to diametrically opposite locations on the helical paths.

11. The buffer conveyor according to claim 1, wherein the inlet and the outlet end join the first and the second conveyor, respectively, from the inner radius.

12. The buffer conveyor according to claim 1, wherein the transfer unit is guided for describing a helical path parallel to the helical paths of the first and the second conveyor.

13. The buffer conveyor according to claim 12, wherein the driving mechanism comprises a vertical shaft, which is co-axial with the axis of the helical path of the first and the second conveyor, wherein the transfer unit is guided along said vertical shaft and can be driven by said shaft or relative to said shaft for describing said helical path.

14. The buffer conveyor according to claim 12, wherein the driving mechanism of the transfer unit comprises two driving wheels which are rotatably connected to the transfer unit, which driving wheels are in engagement with one another at their circumference on the one hand and which are each in engagement with one of said first and said second conveyor on the other hand, thus causing the transfer unit to move in dependence on the speed of the first and the second conveyor.

15. The buffer conveyor according to claim 12, wherein the driving mechanism of the transfer unit comprises a driving motor mounted on the transfer unit, which is in engagement with a helical fixed guide for the first and/or the second conveyor.

16. The buffer conveyor according to claim 12, wherein the driving mechanism comprises a shaft mounted to the transfer unit, to which shaft driving wheels are rigidly connected, which driving wheels are each in engagement with one of said first and said second conveyor, said shaft being mounted to the transfer unit in such a manner as to be capable of applying a moment to the transfer unit for driving the transfer unit in dependence on the speed of the first and the second conveyor.

17. The buffer conveyor according to claim 1, wherein the driving mechanism of the transfer unit is also drivingly connected to the transfer element.

18. The buffer conveyor according to claim 1, wherein the helical paths of the first and the second conveyor have at least substantially the same radius of curvature and extend one above the other in at least substantially parallel relationship.

19. A buffer conveyor for conveying and buffering products, comprising:
at least a first elongated conveyor, which can be driven in a first arced path in a first direction and which has an inlet end,
a second elongated conveyor, which can be driven in the opposite direction in a second arced path having the same diameter, and which has a discharge end,
a transfer unit having an inlet end and an discharge end, which are movable at least substantially parallel to the first and the second conveyor in the aforesaid path, which transfer unit is provided with at least one separate, drivable transfer element for transferring the products from the first conveyor to the second conveyor, so that the products can be transferred from the inlet end of the first conveyor to the discharge end of the second conveyor via the transfer unit, which transfer unit comprises a drive unit for moving the transfer unit along the paths of the respective conveyors with its ends, preferably in dependence on the speeds of the first and the second conveyor,
wherein the inlet end and the outlet end of the transfer element of the transfer unit join the first and the second conveyor, respectively, from the inner radius of the arced paths, and in that the path of said at least one transfer element of the transfer unit extends at least substantially horizontally between said inlet end and said outlet end.
